(19) United States
(12) Patent Application Publication
(10) Pub. No.: US 2007/0203669 A1
(43) Pub. Date: Aug. 30, 2007

(54) Performance monitoring method and system for a single shaft combined cycle plant

(76) Inventor: Yoshiharu Hayashi, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/710,422

(22) Filed: Feb. 26, 2007

(30) Foreign Application Priority Data
Feb. 28, 2006 (JP) 2006-053036

(51) Int. Cl. G06F 17/40; G06F 17/00

(52) U.S. Cl. 702/185; 702/127; 702/182; 702/183; 702/189

(57) ABSTRACT

A performance monitoring system for monitoring the performance of a single shaft combined cycle plant having a steam turbine, a gas turbine and a generator connected by a single shaft, comprising: a gas turbine calculation means 2 for estimating a gas turbine output and a gas turbine exhaust gas temperature from a process value related to the gas turbine; a steam turbine calculation means 3 for estimating a steam turbine output from a process value related to the steam turbine; and a performance monitoring calculation means 6 which, in the case where the difference between the total of the estimate values for the estimated steam turbine output and the estimated gas turbine output and the actual measurement of the generator output exceeds a prescribed value, if the difference between the estimate value of the gas turbine exhaust gas temperature and the actual measurement of the gas turbine exhaust gas temperature exceeds another prescribed value, determines gas turbine abnormality, while if the difference between the estimate value of the gas turbine exhaust gas temperature and the actual measurement of the gas turbine exhaust gas temperature does not exceed the another prescribed value, determines steam turbine abnormality.

### CLAIM OF PRIORITY

The present application claims priority from Japanese application serial No. 2006-053036, filed on Feb. 28, 2006, the contents of which is hereby incorporated by reference into this application.

### BACKGROUND OF THE INVENTION

1. Field of Technology

The present invention relates to a performance monitoring method and system for a single shaft combined cycle plant.

2. Prior Art

The combined cycle plant which generates electric power using both gas turbine and steam turbine includes multishaft type in which different each generator is connected to the gas turbine and the steam turbine respectively and single shaft type in which the gas turbine, the steam turbine and a generator are connected by a single shaft. In the single shaft combined cycle plant, measurement of the generator output generated solely by the gas turbine is difficult.

For this reason, in the single shaft combined cycle plant, the individual output of the gas turbine is obtained by calculations based on process values such as temperature, flow rate, pressure and the like. For example, in Japanese Patent Application Laid-open Publication No. Hei 5-195720, the steam turbine output is first obtained by calculation, and then the gas turbine output is obtained by subtracting the calculated value of the steam turbine output from the actual value for generator output.

In the prior art, the steam turbine output is determined by giving consideration to the effect of age deterioration using the internal efficiency reduction ratio curve for the internal efficiency value which does not include performance deterioration and has been culculated based on the operating conditions (main steam pressure and main steam temperature). The internal efficiency reduction ratio curve herein, indicates the level of efficiency reduction for an operation time determined based on the actual operating result data for a similar steam turbine. This curve also corrects using the clearance value for each section that is measured at the time of periodic inspections.

Patent Document 1: Japanese Patent Application Laid-open Publication No. Hei 5-195720

### SUMMARY OF THE INVENTION

As described above, in the prior art, the steam turbine output is calculated based on the actual operating results of a similar steam turbine. Thus, if the performance deterioration of the steam turbine progresses so as to exceed actual operating results, an error in the calculated value for the steam turbine output will be large. This causes an error in the gas turbine output calculation to be large.

This problem causes a reduction in the accuracy of performance monitoring for combined cycle plants.

The object of the present invention is to provide a performance monitoring system in the single shaft combined cycle plant which carries out highly accurate performance monitoring even in the case where performance deterioration exceeds actual operating results.

In the present invention, the single shaft combined cycle plant obtains calculations for both steam turbine output and gas turbine output and uses the calculated value for the total steam turbine and gas turbine output. In addition to this output, gas turbine exhaust gas temperature is also obtained by calculation.

The calculated value for the total output of the steam turbine and the gas turbine and the actual value of the generator output are compared, and if the difference is large, it is determined that performance deterioration which exceeds actual operating results is progressing at the steam turbine or the gas turbine. Furthermore, if the difference between the calculated value and the actual value for the discharge gas temperature of the gas turbine is large, it is determined that performance deterioration which exceeds actual operating results is occurring at the gas turbine, while if the difference is small, it is determined that this is occurring at the steam turbine.

According to the present invention, highly accurate performance monitoring is carried out in the single shaft combined cycle plant even in the case where performance deterioration exceeds actual operating results.

### BRIEF DESCRIPTION OF THE DRAWINGS

FIG. 1 is a schematic block diagram to show the structure of the performance monitoring system in an embodiment of the present invention.

FIG. 2 is a block diagram to show the structure of the performance monitoring calculation section in FIG. 1.

FIG. 3 is an example to show the contents of the process value database in the performance monitoring system in FIG. 1.

FIG. 4 is an example to show the contents of the GT/ST calculation results database in the performance monitoring system in FIG. 1.

FIG. 5 is an example to show the contents of the thermal efficiency calculation results database in the performance monitoring system in FIG. 1.

FIG. 6 is an example of the set parameters for gas turbine output calculation in the performance monitoring system in FIG. 1.

FIG. 7 is a flow chart to show the process for gas turbine output calculation in the performance monitoring system in FIG. 1.

FIG. 8 is an example of the set parameters for steam turbine output calculation in the performance monitoring system in FIG. 1.

FIG. 9 is a flow chart to show the process for steam turbine output calculation in the performance monitoring system in FIG. 1.

FIG. 10 is an example to show the i-s line chart to be used for the steam turbine output calculation in the performance monitoring system in FIG. 1.

FIG. 11 is a flow chart to show the process for the performance monitoring calculation section in the performance monitoring system in FIG. 1.

FIG. 12 is an example to show on the display screen in the performance monitoring system in FIG. 1 when gas turbine abnormality is occurred.

FIG. 13 is an example to show on the display screen in the performance monitoring system in FIG. 1 when steam turbine abnormality is occurred.

### DETAILED DESCRIPTION OF THE INVENTION

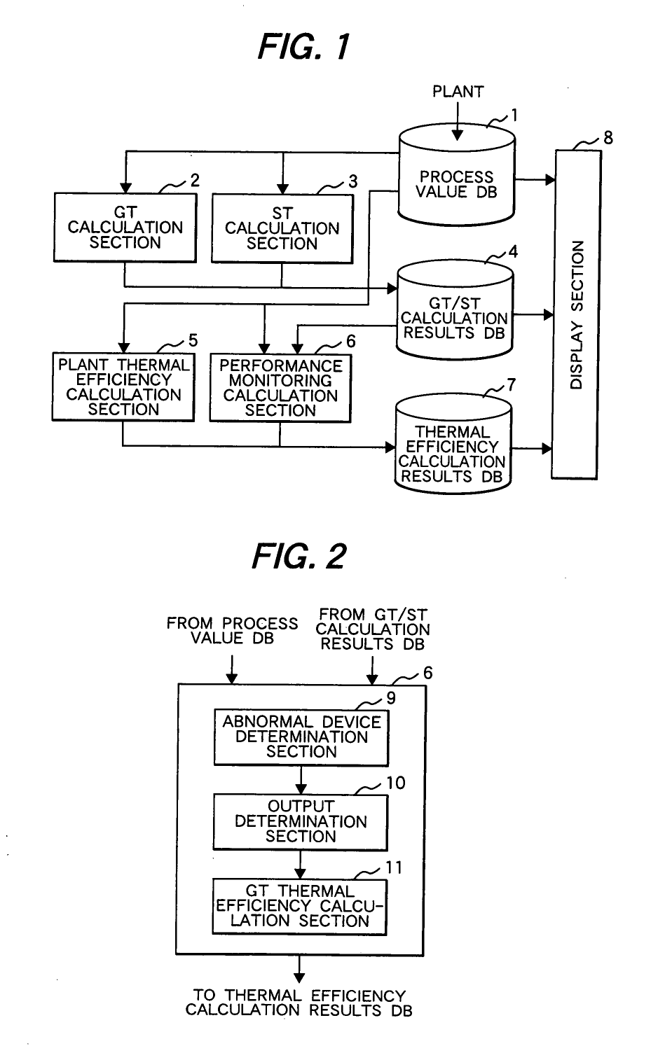

An embodiment of the present invention will be described in the following with reference to the drawings. FIG. 1 is a schematic block diagram to show the structure of the performance monitoring system for a single shaft combined cycle (C/C) plant in an embodiment of the present invention. The performance monitoring system comprises a database for storing each type of data; calculation sections which are calculators; and a display section which displays process values and calculation results. The calculator herein includes memory and a CPU. The calculator comprises the GT calculation section 2, the ST calculation section 3, the plant thermal efficiency calculation section 5, and the performance monitoring calculation section 6. These calculation sections may be separate modules which are processed by one calculator and the respective calculation sections can be performed at the each of a plurality of calculators.

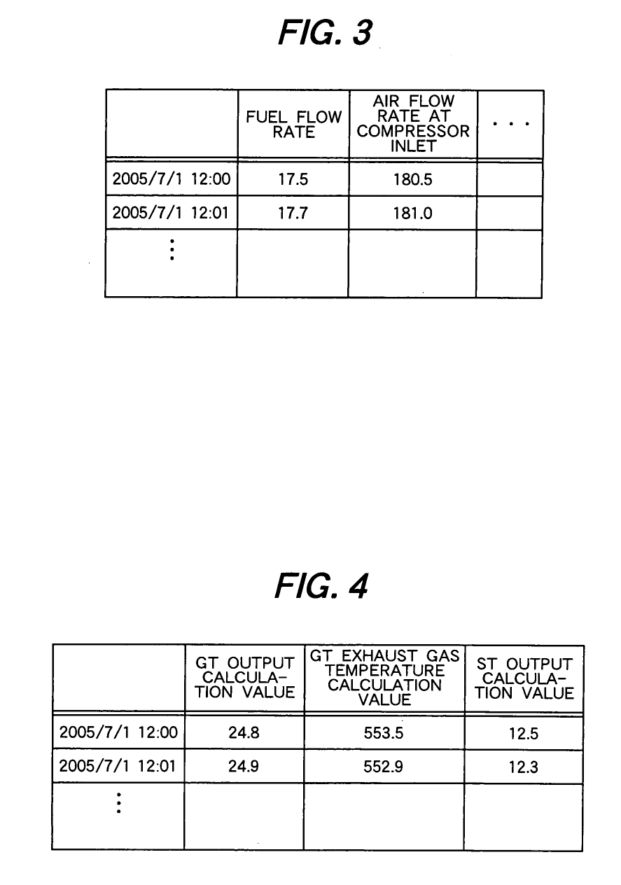

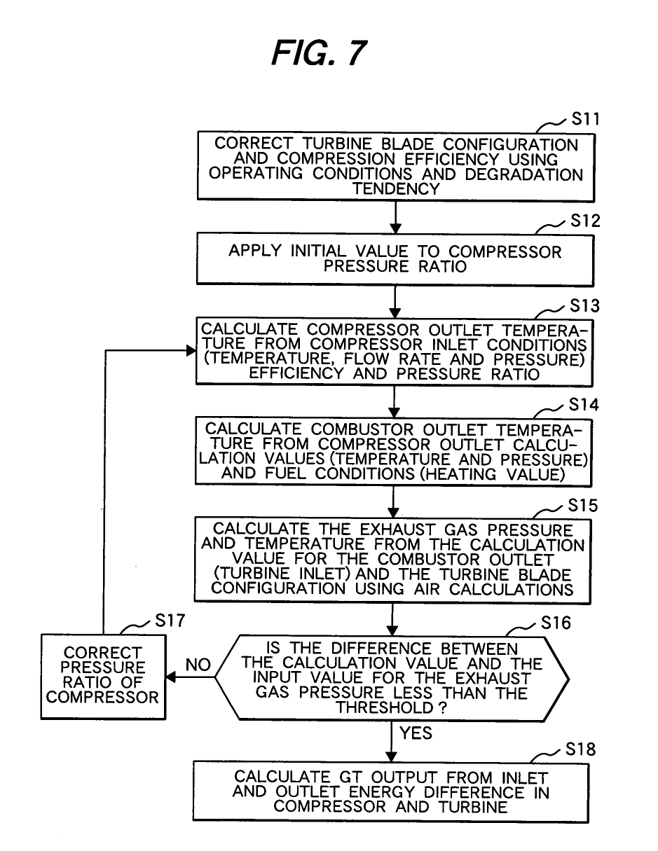

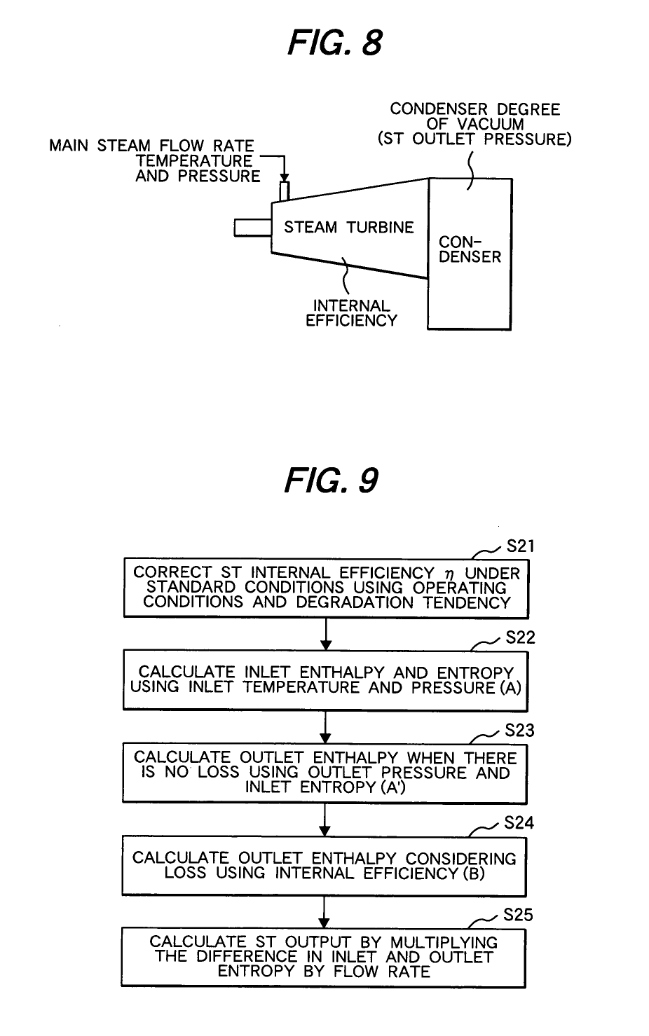

In the FIG. 1, the data for the process values that are fetched from the plant control panel are stored in the process value database (DB) 1. FIG. 3 shows an example of the contents of the process value database(DB) 1 in the performance monitoring system in the FIG. 1. The process value data required for thermal efficiency calculation are stored in a time series in the process value database(DB) 1. In the FIG. 1, next, the GT calculation section 2 calculates the GT output in accordance with operating conditions, based on the process values stored in process value database 1. GT herein indicates gas turbine. GT output calculation is described hereinafter using FIG. 6 and FIG. 7. Similarly, the ST calculation section 3 calculates the ST output. ST herein indicates steam turbine. ST output calculation is described hereinafter using FIG. 8 and FIG. 9.

The calculation method for GT output and GT discharge gas temperature in the GT calculation section 2 will be described using FIG. 6 and FIG. 7. FIG. 6 shows the input parameters for the GT calculation section 2 and a schematic construction of the gas turbine. The gas turbine comprises a compressor, a combustor, and a turbine (expander) and the process value and the set value which input by calculation for each component device are shown. The flow rate, temperature and pressure of the inlet air are set as the input for the compressor. In addition, the fuel flow rate and the heating value per mass unit of fuel are set as the combustor input. These two define the heating value input into the combustor. In addition, the discharge gas pressure at the turbine outlet is set as the outlet condition. And the compressor efficiency is set for the evaluation of the compressor. This may be a value obtained by calculation from the actual value or a set value corrected in accordance with the operating conditions (inlet air temperature and pressure). At this time, factoring in the deterioration trend for the compressor efficiency obtained using the operating result may be considered. On the other hand, in this embodiment, the blade dimension is set for evaluation of the turbine side. In this case also, setting a blade configuration which factors in deterioration trend (for example one in which clearance at the moving blade tip portion is increased) may be considered. GT output and GT discharge gas temperature is calculated from the above input conditions based on the overall heat balance of the compressor, combustor and turbine.

FIG. 7 shows the flow chart of the calculation process in the GT calculation section 2. First the blade configuration is corrected by deterioration trend and then compressor efficiency under standard conditions is corrected using operation conditions and the deterioration trend (S11). Next, the initial value is applied to the compressor pressure ratio (ratio of inlet pressure and outlet pressure) (S12). Next, the compressor outlet temperature is calculated from compressor inlet conditions (temperature, pressure and flow rate) applied by input, the compressor efficiency and the compressor pressure ratio set at S12 (S13). Next, combustor outlet temperature is calculated from compressor outlet flow rate, temperature and pressure (combustor inlet conditions) and fuel heating value (S14). The temperature at the combustor outlet as it is becomes the turbine inlet temperature and thus the temperature and pressure at the turbine outlet are calculated from the flow rate, temperature and pressure at the turbine inlet and the turbine blade configuration using aerodynamic calculations (S15). The turbine outlet pressure as it is, becomes the exhaust gas pressure, and thus the calculated value and the input value are compared, and if the difference between both exceed the threshold value, the pressure ratio that was set as the initial value in Step S12 is corrected, and the processes from S13-S15 are repeated (S16 and S17). If the difference between the calculated value and the input value of the exhaust gas pressure from convergent calculation is less than the threshold value, this indicates consistency in the overall heat balance of the gas turbine (S16). At this time, the energy difference at the inlet and outlet of the turbine is the output obtained at the turbine side and the energy difference at the compressor inlet and outlet is the dynamic energy used at the compressor. The gas turbine output is obtained from the difference between them (S18).

Next, the calculation method in the ST calculation section 3 will be described using FIG. 8 and FIG. 9. FIG. 8 shows the input parameters for the ST calculation 3 and a schematic construction of the steam turbine. Main steam temperature, flow rate and pressure are set as the input for the steam turbine. and degree of vacuum in the condenser (equivalent to the steam turbine outlet pressure) is set as the output. Rated operation and the like are given as examples of the conditions when setting the main steam temperature, flow rate and pressure and the degree of vacuum in the condenser, but those conditions are called standard conditions. Also, the steam turbine internal efficiency uses a set value corrected in accordance with operating conditions (the main steam temperature, the flow rate and the pressure and the degree of vacuum in the condenser). At this time, factoring in the deterioration trend for the steam turbine internal efficiency obtained using the operational performance may be considered. The steam turbine output is calculated based on the steam turbine heat balance from the above input conditions.

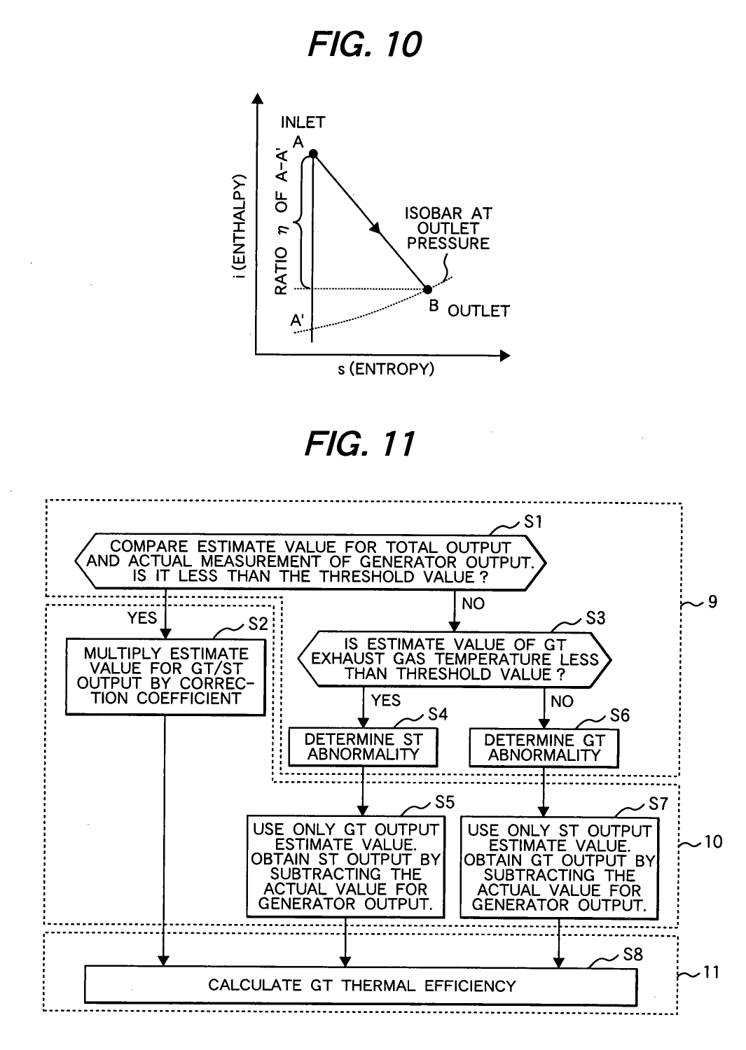

FIG. 9 shows the flow chart of the calculation process in the ST calculation section 3. First, the steam turbine internal efficiency η under standard conditions is corrected using the operating conditions and the deterioration trend (S21). Next, enthalpy i and entropy s are calculated using the inlet temperature and the pressure set by the input (S22). The steam turbine output calculation is performed based on the i-s line diagram shown in FIG. 10. A in FIG. 10 shows the state at the inlet. Next, outlet enthalpy is obtained by assuming that there is no energy loss from heat dissipation, friction and the like (that is entropy is in the same state as at the inlet), based on the outlet pressure set as the input parameter (S23). A′ in FIG. 10 shows this state. Next, outlet enthalpy is obtained considering energy loss based on the internal efficiency corrected at S21 (S24). B in FIG. 10 shows this state. Finally, the difference in the enthalpy between inlet A and outlet B is multiplied by the steam flow rate set as the input parameter to obtain the steam turbine output (S25).

The calculation results for the GT calculation section 2 and the ST calculation section 3 are stored in the GT/ST calculation results DB4 in FIG. 1. FIG. 4 shows an example of the contents of the GT/ST calculation results database 4 in the performance monitoring system in the FIG. 1. The calculation value of the gas turbine output and the gas turbine exhaust gas temperature that were output by the GT calculation section 2, and the calculation value for the steam turbine output that was output by the ST calculation section 3 are stored in a time series. The time corresponds with the time for the process value data used in the calculations.

Next, the performance monitoring calculation section 6 calculates the gas turbine thermal efficiency. In the case where performance deterioration exceeds actual operating results due to abnormality and the like, the difference in the estimate value and the actual value for the gas turbine output or the steam turbine output will be large and thus after the performance monitoring calculation section 6 corrects the calculation values for the respective outputs, the thermal efficiency calculation is performed. The following is a description of process method at the performance monitoring calculation section 6.

FIG. 2 shows the block diagram of the performance monitoring calculation section 6 in FIG. 1. First, the abnormal device determination section 9 determines whether the performance of the gas turbine or the steam turbine is deteriorating in excess of actual operating results due to deterioration or the like. Next, the output determining section determines the final value for the gas turbine output and the steam turbine output based on the determination results at the abnormal device determination section 10. Finally, the GT turbine thermal efficiency calculation section 11 calculates the gas turbine thermal efficiency using the gas turbine output value obtained in the output determination section 10.

FIG. 11 is a flow chart to show the process for the performance monitoring calculation section 6 in detail. The process flow will be described in the following using FIG. 11.

The abnormal device determination section 9 fetches the actual measurement of the generator output stored in the process value DB1 and the calculation value for the gas turbine output, the steam turbine output and the exhaust gas temperature stored in the GT/ST calculation results database 4 and determines whether there is a gas turbine or steam turbine abnormality. If age deterioration of the gas turbine and the steam turbine progress to the same degree as actual operating results, it is expected that the calculation value for total output which is the sum of gas turbine output and steam turbine output will be the same as he actual measurement of generator output if calculation errors are excluded. First, the abnormal device determination section 9 compares the calculation value for total output and the actual measurement of generator output and determines whether the difference of them is less than the threshold value (S1).

If the difference value between them is less than the threshold value of output, this indicates that the degree of gas turbine/steam turbine performance deterioration and actual operating results is the same. In this case, the output determination section 10 performs correction to remove the effect of the calculation error for the both calculation values for the gas turbine output and the steam turbine output to obtain the final value of the output (S2). The correction is performed by multiplying both calculation values for the gas turbine output and the steam turbine output by the same value such that the calculation value for total output perfectly matches the actual measurement of the generator output.

Meanwhile, if the difference value between them exceeds the threshold value of output, a determination is made that an abnormality has occurred at the gas turbine or the steam turbine. In order to identify where the abnormality has occurred, the calculated value and the actual measurement of the gas turbine exhaust gas temperature are compared (S3). If the difference value between the calculated value and the actual measurement of the gas turbine exhaust gas temperature is less than the threshold value of temperature, a determination is made that the gas turbine is normal, or in other words, and abnormality has occurred at the steam turbine (S4). Similarly, if the difference value between the calculated value and the actual measurement of the exhaust gas temperature exceeds the threshold value of temperature, a determination is made that an abnormality has occurred at gas turbine (S6). In this manner, the total of the gas turbine output estimate value and the steam turbine output estimate value is compared with the actual measurement, and in addition by comparing the estimate value for the gas turbine exhaust gas temperature and the actual measurement of the gas turbine exhaust temperature, even in the case where performance deterioration is generated which exceeds actual operating results, the turbine where deterioration occurs can be identified, and the turbine with exhaust gas abnormality can be identified.

The output determination section 10 calculates output after the steam turbine or the gas turbine in which the abnormality occurs is removed. In the case where a determination is made above (S4) that an abnormality occurred at the steam turbine, there is a discrepancy between calculated value for steam turbine output and the actual measurement of the steam turbine output and thus this is not used and only the gas turbine output calculation value is used. The steam turbine output is obtained by subtracting calculation value for gas turbine output from the actual measurement of generator output (S5). In the case where a determination is made above (S6) that an abnormality occurred at the gas turbine, gas turbine output is obtained by subtracting calculation value for steam turbine output from the actual measurement of generator output (S7). In this manner, the calculation value for device in which performance deterioration occurs which exceeds actual operating results has a large error and thus this is not used in output evaluation. The calculation value of output for the device in which no performance deterioration occurs is subtracted from the actual measurement of generator output, and the output for the device in which performance deterioration occurs is obtained. As a result, the output of the turbine in which deterioration has progressed is excluded and an accurate steam turbine output and gas turbine output can be determined.

Next, the performance monitoring calculation section 6 calculates gas turbine thermal efficiency based on the obtained gas turbine output value using the GT thermal efficiency calculation section 11. Thermal efficiency is the indicator for monitoring changes in individual performance of the gas turbine. It is shown by the proportion of the electrical output generated by the gas turbine with respect to the input heating value to the gas turbine per unit of time. The gas turbine thermal efficiency is calculated by dividing the gas turbine output by the fuel heating value per unit of time.

In the device for which thermal efficiency is calculated using the turbine internal efficiency reduction curve, in the case where deterioration is progressing, it is necessary to wait for correction of the internal efficiency reduction curve by clearance measured data for periodic inspections. However, as is the case above, regardless of which of the steam turbine and gas turbine shows deterioration, abnormality determination for one of the steam turbine and gas turbine is carried out, and the output for the normal turbine can be determined from the abnormal turbine and thus the correct efficiency for the abnormal turbine can be determined. As a result, the correct efficiency of the abnormal turbine can be quickly determined without waiting for periodic inspection.

The process flow at the performance monitoring calculation section 6 was described above. Further, the plant thermal ratio calculation section 5 calculates the overall plant thermal efficiency, or in other words, the total plant thermal efficiency for both gas turbine and steam turbine. The plant thermal efficiency is calculated by dividing the actual value for generator output (total gas turbine and steam turbine output) by the fuel heating value per unit of time.

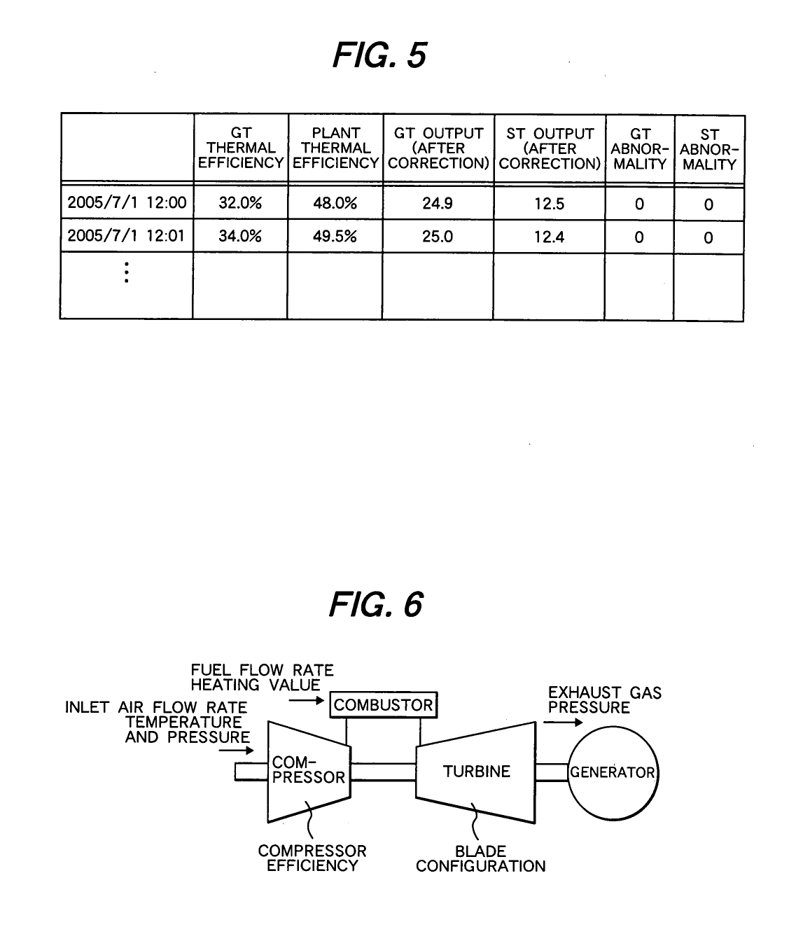

The data for thermal efficiency calculated at the performance monitoring calculation section 6 and the plant thermal ratio calculation section 5 are stored in the thermal efficiency calculation results DB7. FIG. 5 shows an example of the contents of the thermal efficiency calculation results database(DB) 7 in the performance monitoring system in the FIG. 1. In addition to the values for the gas turbine thermal efficiency and the plant thermal efficiency which are the final results, the value for the corrected gas turbine/steam turbine output calculated by the performance monitoring calculation section 6, and the gas turbine/steam turbine abnormality determination results (0 represents normal and 1 represents normal) are also stored.

The data for the actual measurements and calculation values stored in the database of this system is output to the user interface via the display section 8.

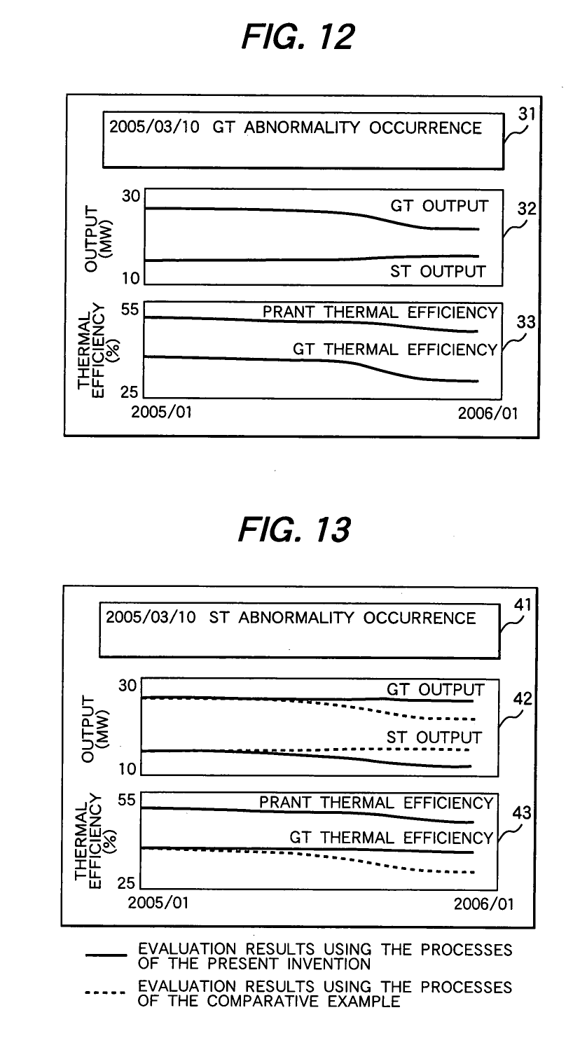

FIG. 12 shows an example of the display screen in the performance monitoring system. The display region 31 is abnormality information that is shown based on the gas turbine/steam turbine abnormality data stored in the thermal efficiency calculation results DB 7. The display region 32 and the display region 33 are data for the gas turbine/steam turbine output stored in the thermal efficiency calculation results DB 7 (the value after correction by the GT thermal efficiency calculation section 11), plant thermal efficiency and gas turbine thermal efficiency. In this display example, gas turbine output decreases due to the occurrence of an abnormality at gas turbine and the steam turbine output is increased in order to compensate for the decrease. Based on this, the gas turbine thermal efficiency and the plant thermal efficiency have a decrease trend.

FIG. 13 shows an example of the display screen in the performance monitoring system when steam turbine abnormality occurs. The display region 41 is abnormality information that is shown based on gas turbine/steam turbine abnormality data stored in the thermal efficiency calculation results DB 7. The display region 42 displays the gas turbine output and the steam turbine output. The displayed gas turbine output is the gas turbine output estimate value that is stored in the thermal efficiency calculation results DB 7, and the displayed steam turbine output is a value obtained by subtracting the gas turbine output estimate calculated at the GT calculation section 2 from the actual measurement of generator output. The display region 43 displays the plant thermal efficiency and the gas turbine thermal efficiency. The gas turbine thermal efficiency is a value calculated at the GT thermal efficiency calculation section 11 from the gas turbine output estimate value. In this display example, the steam turbine output decreases due to the occurrence of an abnormality at the steam turbine, and the gas turbine output is increased in order to compensate for the decrease. Based on this, the gas turbine thermal efficiency and the plant thermal efficiency have a decrease trend.

The comparative example output and calculation results of thermal efficiency are shown by a broken line. The comparative example shows the case in which even if performance deterioration exceeds actual operating results progresses, this is not determined, and the steam turbine output is calculated based in the actual operating results of a similar steam turbine. Accordingly, the amount of the steam turbine output deterioration is calculated as the gas turbine output deterioration, and the gas turbine thermal efficiency is displayed as decreasing and the accuracy of performance monitoring decreases.

In the display 8, the output of the display for the display region 42 can be changed corresponding the steam turbine abnormality or the gas turbine abnormality at the display region 41. In the case of the steam turbine abnormality, the gas turbine output shows that it is the gas turbine output estimate value of the GT calculation section 2 and the steam turbine output displays that it is the value obtained by subtracting the gas turbine output estimate value from the actual measurement of generator output. The steam turbine output display displays “actual measurement—GT output estimate value” and “calculation from GT output estimate value” in a trend graph. Similarly, in the case of gas turbine abnormality also, the steam turbine output displays that it is the steam turbine output estimate value of the ST calculation section 3 and the gas turbine output shows that it is the value obtained by subtracting the steam turbine output estimate value from the actual measurement of generator output.

In this manner, the abnormality display and the output display correspond, the display for the steam turbine or gas turbine in which an abnormality occurs displays the calculations based on the output obtained by calculation for the gas turbine or steam turbine that is not abnormal, and thus it is easy for the operator to determine which output is the being used as the standard. In the above embodiment, abnormality determination is performed at the abnormal device determination section 9 based on the gas turbine exhaust gas temperature, but gas turbine or steam turbine abnormality determination is not limited thereto and may be performed based on other plant data for gas turbine or steam turbine. That is to say, in the case where, the GT calculation section 2 which estimates gas turbine output from process values relating to gas turbine; the ST calculation section 3 which estimates ST output from process values relating to steam turbine; or the abnormal device determination section 9 which determines gas turbine or steam turbine abnormality based on the process values for the steam turbine or the gas turbine, determine the steam turbine abnormality, even when there is abnormality at one turbine, output can be accurately determined by the performance monitoring system which comprises an output determination section which, in the case where gas turbine abnormality is determined, calculates gas turbine output from the difference between the actual measurement of generator output and the estimate value for steam turbine output, and in the case where steam turbine abnormality is determined, calculates steam turbine output from the difference between the actual measurement of generator output and the estimate value for gas turbine output.

In the above embodiment, when there is an abnormality in the gas turbine or the steam turbine, calculations are done for both output and thermal efficiency and then output, but calculations and output may be done for any one.

Of the multi-shaft and single shaft type combined cycle plants, the difficulty of measuring the generator output generated solely by the gas turbine in the single shaft combined cycle plant has been described. In this single shaft type combined cycle plant, it is possible to install a torque detector to perform measurements, but installing a detector is difficult when the high cost of the installation is considered.

The present invention can be used in the monitoring system for a single shaft combined cycle generation plant.

What is claimed is:

1. A performance monitoring system for monitoring the performance of a single shaft combined cycle plant having a steam turbine, a gas turbine and a generator connected by a single shaft, comprising:
a gas turbine calculation means for estimating a gas turbine output and a gas turbine exhaust gas temperature from a process value related to the gas turbine;
a steam turbine calculation means for estimating a steam turbine output from a process value related to the steam turbine; and
a performance monitoring calculation means which, in the case where the difference between the total of the estimate values for the estimated steam turbine output and the estimated gas turbine output and the actual measurement of the generator output exceeds a prescribed value, if the difference between the estimate value of the gas turbine exhaust gas temperature and the actual measurement of the gas turbine exhaust gas temperature exceeds another prescribed value, determines gas turbine abnormality, while if the difference between the estimate value of the gas turbine exhaust gas temperature and the actual measurement of the gas turbine exhaust gas temperature does not exceed the another prescribed value, determines steam turbine abnormality.

2. A performance monitoring system according to claim 1, wherein the performance monitoring calculation means further comprising an output determination means in which, in the case where gas turbine abnormality is determined, gas turbine output is calculated from the difference between the actual measurement of the generator output and the estimated value of the steam turbine output, and in the case where steam turbine abnormality is determined, steam turbine output is calculated from the difference between the actual measurement of the generator output and the estimated value of the gas turbine output.

3. A performance monitoring system according to claim 2, wherein the performance monitoring calculation means further comprising a thermal efficiency calculation means to calculate a thermal efficiency by using the estimated value of the gas turbine output or the estimated value of the steam turbine output.

4. A performance monitoring system according to claim 1, wherein the performance monitoring system further comprising a display means for displaying the estimate values for the gas turbine output or the steam turbine output.

5. A performance monitoring system according to claim 3, wherein the performance monitoring system further comprising a display means for displaying the calculated thermal efficiency.

6. A performance monitoring method in a performance monitoring system for monitoring the performance of a single shaft combined cycle plant having a steam turbine, a gas turbine and a generator connected by a single shaft, wherein the performance monitoring system performs the steps of:
estimating a gas turbine output and a gas turbine exhaust gas temperature from a process value related to the gas turbine;
estimating a steam turbine output from a process value related to the steam turbine, and
determining an abnormality of gas turbine or steam turbine which, in the case where the difference between the total of the estimate values for the estimated steam turbine output and the estimated gas turbine output and the actual measurement of the generator output exceeds a prescribed value, if the difference between the estimate measurement of the gas turbine exhaust gas temperature and the actual measurement of the gas turbine exhaust gas temperature exceeds another prescribed value, determining gas turbine abnormality, while if the difference between the estimate value of the gas turbine exhaust gas temperature and the actual measurement of the gas turbine exhaust gas temperature does not exceed the another prescribed value, determining steam turbine abnormality.

7. A performance monitoring method according to claim 6, wherein in the case where the gas turbine abnormality is determined, the performance monitoring system calculates the gas turbine output from the difference between the actual measurement of the generator output and the estimated value of the steam turbine output, and in the case where the steam turbine abnormality is determined, the performance monitoring system calculates the steam turbine output from the difference between the actual measurement of the generator output and the estimated value of the gas turbine output.

8. A performance monitoring method according to claim 7, wherein the performance monitoring system calculates a thermal efficiency by using the estimated value of the gas turbine output or the estimated value of the steam turbine output.

9. A performance monitoring method according to claim 6, wherein the estimate values for gas turbine output or steam turbine output are displayed.

10. A performance monitoring method according to claim 8, wherein the calculated thermal efficiency is displayed.

11. A performance monitoring system for monitoring the performance of a single shaft combined cycle plant having a steam turbine, a gas turbine and a generator connected by a single shaft, comprising:
a gas turbine calculation means for estimating a gas turbine output from a process value related to the gas turbine;
a steam turbine calculation means for estimating a steam turbine output from a process value related to the steam turbine;
a determining means for determining gas turbine abnormality or steam turbine abnormality based on the gas turbine process value or the steam turbine process value; and
an output determining means which, in the case where gas turbine abnormality is determined, calculates the gas turbine output from the difference between the actual measurement of the generator output and the estimated value of the steam turbine output, and in the case where steam turbine abnormality is determined, calculates the steam turbine output from the difference between the actual measurement of the generator output and the estimated value of the gas turbine output.

12. A performance monitoring system of claim 11, wherein the performance monitoring system further comprising a display means for displaying information calculated in the output determining means, and the display means displays the output for the steam turbine or gas turbine which is abnormal, based on the output obtained by using calculation for a gas turbine or a steam turbine which is not abnormal.
